(19) United States
(12) Patent Application Publication
(10) Pub. No.: US 2019/0370747 A1
(43) Pub. Date: Dec. 5, 2019

(54) METHOD FOR PROCESSING LOGISTICS PACKAGE DELIVERY ROUTE, AND RELATED DEVICE

(71) Applicant: CAINIAO SMART LOGISTICS HOLDING LIMITED, GRAND CAYMAN (KY)

(72) Inventors: Mengyuan FENG, HANGZHOU (CN); Huaqiang ZHANG, HANGZHOU (CN); Xiaohua CHEN, HANGZHOU (CN)

(21) Appl. No.: 16/541,455

(22) Filed: Aug. 15, 2019

Related U.S. Application Data
(63) Continuation of application No. PCT/CN2018/075536, filed on Feb. 7, 2018.

(30) Foreign Application Priority Data
Feb. 20, 2017 (CN) 201710089847.5

(51) Int. Cl. G06Q 10/08; G01C 21/34

(52) U.S. Cl. CPC G06Q 10/08355; G01C 21/343

(57) ABSTRACT

A method for processing a delivery route of a logistics package and related device may provide collecting and sorting a plurality of pieces of logistics information of a logistics package generated by a logistics system. The method may include retriving geographical location information from the pieces of logistics information. The geographical location information is geographical locations that the logistics package traverses during delivery. The geographical locations are connected according to an order of the logistics information to obtain a delivery route of the logistics package. The method may also include using logistics information in a logistics system such that a positioning apparatus is not required to be installed on every delivery tool. In addition, this application may provide a server and a terminal to ensure actual application and implementation of the foregoing method.

### CROSS-REFERENCE TO RELATED APPLICATIONS

This application is a continuation application of International Patent Application No. PCT/CN2018/075536, filed on Feb. 7, 2018, which is based on and claims priority to the Chinese Patent Application No. 201710089847.5, filed on Feb. 20, 2017 and entitled “METHOD FOR PROCESSING LOGISTICS PACKAGE DELIVERY ROUTE, AND RELATED DEVICE”, the content of all of which is incorporated herein by reference in their entirety.

### TECHNICAL FIELD

This application relates to the field of logistics management technology, and more specifically, to a method for processing a delivery route of a logistics package and related devices.

### BACKGROUND

In a logistics system, when a package is delivered from an origin to a destination, a delivery path can be presented to a user more visually in the form of a map in addition to a text.

Currently, a GPS navigation apparatus needs to be installed on a delivery device such as a delivery vehicle, to generate a delivery path of a package. After the location of the package is received in real time from the GPS navigation apparatus, the coordinates of the location are displayed on a map to form the delivery path of the package. However, in this manner, a navigation apparatus needs to be installed on every delivery device, resulting in relatively high costs.

### SUMMARY

This application provides a method for processing a delivery route of a logistics package, to resolve the problem of relatively high costs of generating a delivery route of a logistics package.

To achieve the objective, this applications provides different embodiments of the technical solutions as shown below. In some embodiments, this application provides a method for processing a delivery route of a logistics package, applied to a server. The method may include determining a plurality of geographical locations corresponding to a plurality of pieces of logistics information of the logistics package. The method may include sorting the plurality of pieces of logistics information to generate an order of the plurality of geographical locations corresponding to the plurality of pieces of logistics information. The method of may include determining, according to the order of the plurality of geographical locations, a delivery route of the logistics package that sequentially traverses the geographical locations.

In some embodiments, this application provides a method for processing a delivery route of a logistics package, applied to a terminal. The method may include sending, in response to a search instruction for a target logistics package, to a server a search request for a delivery route of the target logistics package. The server may be configured to determine a target delivery route corresponding to the target logistics package and return to the terminal the target delivery route. The method may include receiving the target delivery route from the server. The method may include displaying the target delivery route in a first display style on a preset map.

In some embodiments, this application provides a server. The server may include a communications interface and a processor. The communication interface may be configured to obtain a plurality of pieces of logistics information of a logistics package. The plurality of pieces of logistics information of the logistics package may be sent to the processor via the communications interface. The processor may be configured to determine a plurality of geographical locations corresponding to the plurality of pieces of logistics information. The processor may be configured to sort the plurality of pieces of logistics information as an order of the plurality of geographical locations. The processor may be configured to determine, according to the order of the plurality of geographical locations, a delivery route of the logistics package that sequentially traverses the geographical locations.

In some embodiments, this application provides a terminal. The terminal may include a processor, a communications interface, and a display. The processor may be configured to generate, in response to a search instruction for a target logistics package, a search request for a delivery route of the target logistics package. The search request may be used by a server to determine a target delivery route corresponding to the target logistics package and return the target delivery route to the terminal. The processor may send to a communications interface the search request. The communications interface may be configured to send to the server the search request and receive the target delivery route from the server. The display may be configured to display the target delivery route in a first display style on a preset map.

As can be known from the foregoing technical solutions, this application provides a method for processing a delivery route of a logistics package. In the method, a plurality of pieces of logistics information of a logistics package generated by a logistics system may be collected and sorted, and geographical location information is retrieved from the pieces of logistics information. The geographical location information is geographical locations that the logistics package traverses during delivery. The geographical locations are connected according to an order of the logistics information to obtain a delivery route of the logistics package. In the method, logistics information in a logistics system is used and a navigation apparatus does not need to be installed on every delivery tool, and therefore the costs of generating a delivery route are reduced.

### BRIEF DESCRIPTION OF THE DRAWINGS

To describe the technical solutions in the embodiments of this application or the existing technologies more clearly, the following briefly describes the accompanying drawings required for describing the embodiments or the existing technologies. Apparently, the accompanying drawings in the following description show only some embodiments of this application, and a person of ordinary skill in the art may still derive other drawings from the provided accompanying drawings without creative efforts.

FIG. 1 is a schematic diagram of an application scenario for processing a delivery route of a logistics package according to an embodiment of this application;

FIG. 2 is a flowchart of the method for processing a delivery route of a logistics package according to an embodiment of this application;

FIG. 3 is a schematic diagram of the delivery route according to an embodiment of this application;

FIG. 4 is a flowchart of another method for processing a delivery route of a logistics package according an embodiment of to this application;

FIG. 5A is another schematic diagram of a delivery route according to an embodiment of this application;

FIG. 5B is another schematic diagram of a delivery route according to an embodiment of this application;

FIG. 6 is another schematic diagram of a delivery route according to an embodiment of this application;

FIG. 7 is another schematic diagrams of a delivery route according to this application;

FIG. 8 is a block diagram of a server according to an embodiment of this application; and

FIG. 9 is a block diagram of a terminal according to an embodiment of this application.

### DETAILED DESCRIPTION OF THE INVENTION

The following clearly and completely describes the technical solutions in the embodiments of this application with reference to the accompanying drawings in the embodiments of this application. The described embodiments are only some of the embodiments of this application rather than all of the embodiments. All other embodiments obtained by a person of ordinary skill in the art based on the embodiments of this application without creative efforts fall within the protection scope of this application.

In the logistics field, a package needs to be delivered from one place to another place. A delivery path may be displayed on a map for a user to visually obtain information such as a current location and a route of the package. In a current manner of map presentation, a positioning apparatus such as a Global Positioning System (GPS) is installed on a delivery vehicle that carries packages, and real-time positioning data of the positioning apparatus is displayed on a map. In this manner, a positioning apparatus needs to be installed on every delivery vehicle, resulting in relatively high costs.

Accordingly, this application provides a method for processing a delivery route of a logistics package, to generate a delivery route of a logistics package or further present the delivery route. The method is applied to a server, and for ease of distinguishing from another server, the server may be referred to as a first server.

FIG. 1 is a schematic diagram of an application scenario for processing a delivery route of a logistics package. As shown in FIG. 1, a first server may receive logistics information uploaded by a device such as a server on a logistics side. In some embodiments, the server on the logistics side may be referred to as a second server. The first server generates a delivery route of a logistics package according to the logistics information. A device such as a terminal on a user side may send a search request to the first server. The first server may return a map of the delivery route of the logistics package to a terminal on the user side so that the terminal displays the map of the delivery route.

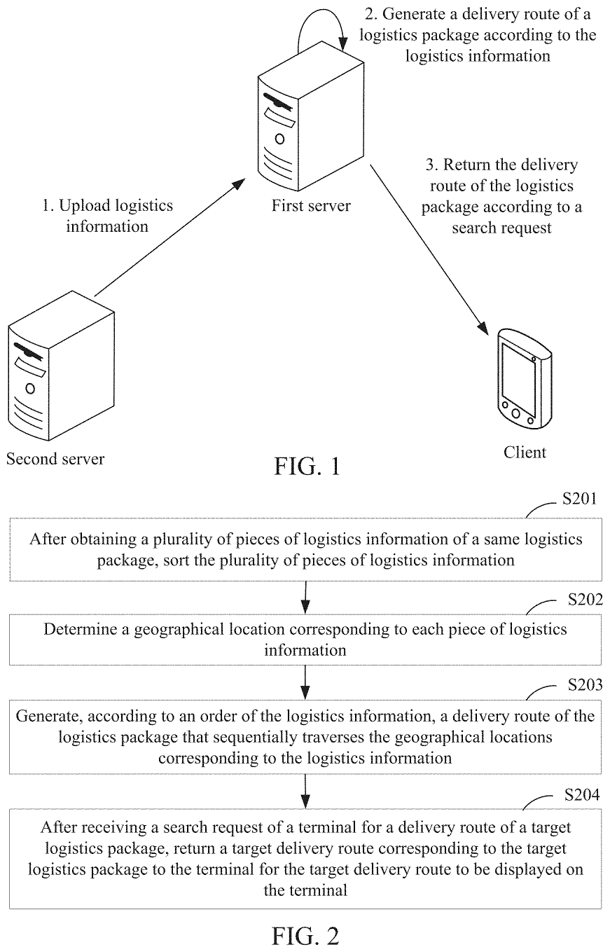

The following focuses on how a first server generates a map of a delivery route of a logistics package according to logistics information. Referring to FIG. 2, a specific procedure of a method for processing a delivery route of a logistics package includes steps S201 to S203.

At S201, after obtaining a plurality of pieces of logistics information of a logistics package, the plurality of pieces of logistics information are sorted.

In some embodiments, a server on a logistics side is the foregoing second server. The server may be a server deployed by a logistics service provider, and therefore may also be referred to as a logistics server. Specifically, the logistics service provider may deploy a logistics system. Acquisition terminals in the logistics system may acquire logistics information of the logistics package during delivery. The logistics information may be information generated when the logistics package is at each logistics transfer location, for example, information indicating the logistics package dispatched from a place A, and information indicating the logistics package entering a logistics forwarder B. The transfer location may include, but is not limited to, an origin, a forwarder, a recipient site, a collection site, and a destination.

The logistics server may send logistics information uploaded by the acquisition terminals to the first server. Each time when one piece of logistics information of a logistics package is received, it may be uploaded to the first server. In some embodiments, a plurality of pieces of logistics information of a logistics package may be uploaded together to the first server.

After receiving the logistics information, the first server sorts the plurality of pieces of logistics information according to a transfer order of the logistics package. In some embodiments, a time point at which logistics information is generated indicates that a transfer stage is completed for the logistics package. Therefore, the transfer order of the logistics package may be reflected by a sequence of generation time of logistics information. For example, the generation time of one piece of logistics information of a logistics package showing “11:23, Jan. 12, 2017,” and the content of the logistics information showing “The logistics package is dispatched,” may indicate that the logistics package is dispatched at 11:23, Jan. 12, 2017. The generation time of another piece of logistics information of the logistics package showing “08:51, Jan. 13, 2017,” and the content of the logistics information showing “The logistics package arrives at the forwarding center A,” may indicate that the logistics package arrives at the forwarding center A at 08:51, Jan. 13, 2017. Therefore, an order of the logistics information is sequentially first logistics information and second logistics information.

In some embodiments, the transfer order of the logistics package may be directly included in logistics information. Specifically, the logistics information may record time points at which transfer stages are completed for the logistics package. Therefore, the time points may be directly retrieved from the logistics information, and a sequence of the time points may be the transfer order of the logistics package. Therefore, the logistics information can be sorted according to the sequence of the time points.

In some embodiments, the order of the logistics information can be determined as long as the transfer order of the logistics package is determined As shown above, the transfer order of the logistics package may reflect a time point at which the logistics information is generated or a time point carried in the logistics information. Both types of time points may be referred to as time points corresponding to the logistics information. The time points may also be referred to as transfer time points of the logistics package. The order of the logistics information may be obtained according to the transfer time points of the logistics package.

At S202, a geographical location corresponding to each piece of logistics information is determined.

The logistics information may include geographical locations to indicate the location of the logistics package in a logistics process. The geographical locations may be a site identifier, a logistics distribution center identifier, an administrative region identifier, geographical coordinates, and etc. In some embodiments, because the geographical locations may be displayed on a map, the geographical coordinates of each geographical location may be determined in advance.

Specifically, a correspondence between logistics information of a non-geographical coordinate type and geographical coordinates may be stored in advance. If a geographical location retrieved from logistics information is not in geographical coordinates, geographical coordinates corresponding to logistics information of a non-geographical coordinate type may be determined according to the correspondence. For example, a piece of logistics information is “Dispatched from Shanghai Pujiang Distribution Center.” In such case, a geographical location included in the logistics information may be a logistics distribution center identifier, “Shanghai Pujiang Distribution Center.” According to a prestored correspondence between “Shanghai Pujiang Distribution Center” and geographical coordinates, a geographical coordinate corresponding to the logistics information may be determined.

It should be noted that the same geographical location may be retrieved from different pieces of logistics information. For example, “Received at Shanghai Pujiang Distribution Center” and “Dispatched from Shanghai Pujiang Distribution Center” are two different pieces of logistics information. However, a geographical location corresponding to “Shanghai Pujiang Distribution Center” is retrieved from the two pieces of logistics information. During the generation of a delivery route, a geographical location only needs to appear once in the delivery route.

It should be noted that this step is not necessarily performed after step S201. Step S202 and step S201 may be performed at the same time. Specifically, after the plurality of pieces of logistics information of the target logistics package is obtained, the geographical locations corresponding to the pieces of logistics information may be determined, and the plurality of pieces of logistics information may be sorted.

At S203, the method may generate, according to an order of the logistics information, a delivery route of the logistics package that sequentially traverses the geographical locations corresponding to the logistics information.

The order of the logistics information may indicate an order of the geographical locations corresponding to the logistics information. According to the order, a route formed of the geographical locations may be used as the delivery route of the logistics package. The geographical locations may be shown on a map. Therefore, the delivery route may be also displayed on the map to reflect content of the delivery route.

It should be noted that there is a correspondence between a delivery route of a logistics package and the logistics package. Specifically, each logistics package may have a respective corresponding delivery route. The correspondence between the delivery route and the logistics package may be specifically reflected in a correspondence between a delivery route and an identifier of a logistics package.

In some embodiments, this application provides a method for processing a delivery route of a logistics package. In some embodiments, a plurality of pieces of logistics information of a logistics package generated by a logistics system may be collected and sorted, and geographical location information is retrieved from the pieces of logistics information. The geographical location information is geographical locations that the logistics package traverses during delivery. The geographical locations are connected according to an order of the logistics information to obtain a delivery route of the logistics package. In the method of using logistics information in the logistics system, a positioning/navigation apparatus may not be required to be installed on every delivery tool, and therefore the costs of generating a delivery route are reduced.

In some embodiments, to reflect a delivery route, as shown in FIG. 2, the method for processing a delivery route of a logistics package may further include the following step S204.

At S204, after receiving a search request of a terminal for a delivery route of a target logistics package is received, a target delivery route corresponding to the target logistics package is returned to the terminal, where the target delivery route may be displayed on the terminal

In some embodiments, the search request for the delivery route may be sent from the terminal. The terminal may be a terminal of a user. Specifically, when intending to search for a delivery route of a logistics package (the logistics package may be referred to as a target logistics package), the user may use the terminal to send the search request to a first server. The search request may include a unique identifier of the logistics package.

In some embodiments, after receiving the search request, the first server determines, according to the unique identifier of the logistics package in the search request, the delivery route corresponding to the unique identifier. For ease of description, the determined delivery route may be referred to as the target delivery route. The first server returns the target delivery route to the terminal that sends the search request.

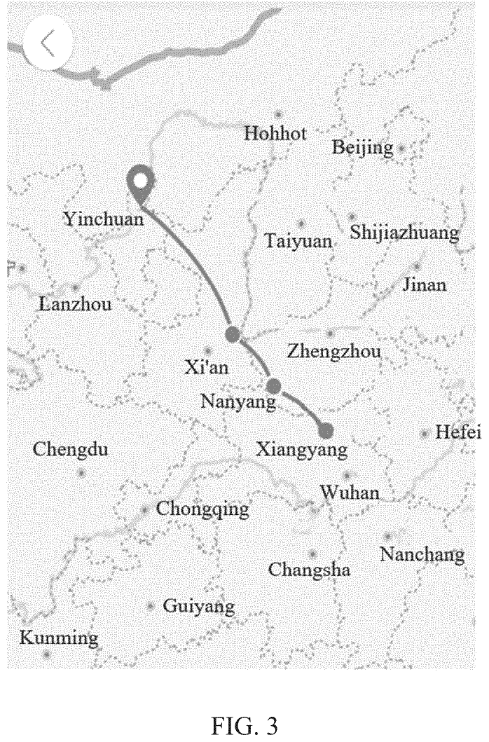

In some embodiments, the terminal may display the delivery route on a map for the user to visually check places that the logistics package traverses during delivery process. FIG. 3 illustrates a schematic diagram of a delivery route of a logistics package. The delivery route, sequentially including “Yinchuan,” “Xi'an,” “Nanyang,” and “Xiangyang,” indicates that the logistics package may sequentially traverse these places.

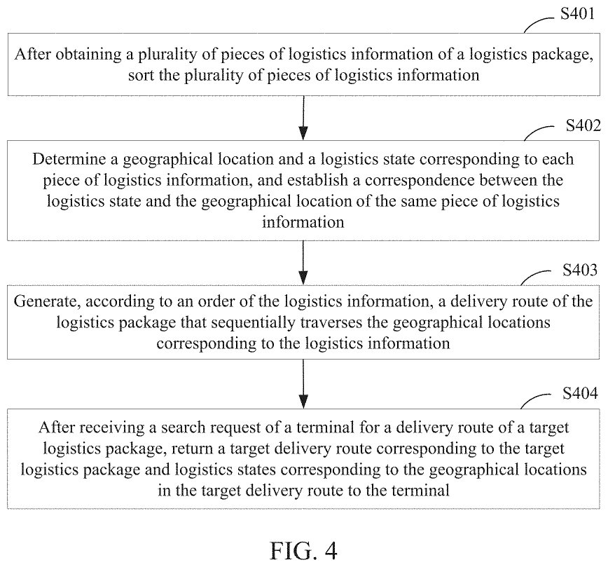

In some embodiments, a logistics state of a logistics package may further be displayed on a delivery route so that a user may determine a logistics stage of the logistics package. FIG. 4 illustrates another method for processing a delivery route of a logistics package in accordance with some embodiments. The method specifically includes steps S401 to S404.

At S401, after obtaining a plurality of pieces of logistics information of a logistics package, the plurality of pieces of logistics information are sorted. This step is the same as step S201 in the method for processing a delivery route of a logistics package shown in FIG. 2. Details are not described herein.

At S402, a geographical location and a logistics state corresponding to each piece of logistics information are determined, and a correspondence between the logistics state and the geographical location of the piece of logistics information is established.

In some embodiments, after receiving the logistics information, the first server may determine the logistics state corresponding to each piece of logistics information according to a preset correspondence between logistics information and a logistics state. The logistics state may be preset, and may be used to indicate a stage or node that the logistics package is at in a logistics process. For example, the logistics state may include, but is not limited to, “To be accepted,” “Dispatched,” “In transit,” “Delivering,” “Collected,” and “Received and signed for.”

Specifically, the logistics information may include a term used to indicate a sub-process of logistics transfer, and a logistics sub-node corresponding to the logistics information may be determined according to the term indicating the sub-process of logistics transfer. In some embodiments, a logistics information mapping table may be set on the first server, where a correspondence between the logistics sub-node and a logistics state may be stored. Therefore, after the logistics sub-node corresponding to the logistics information is determined, the logistics state corresponding to the logistics sub-node may be determined according to the logistics information mapping table. For example, a piece of logistics information is “Dispatched from Shanghai Pujiang Distribution Center.” The logistics sub-node included in the logistics information is “Dispatched.” If the logistics state corresponding to “Dispatched” stored in the logistics information mapping table is “In transit,” it may be determined that the logistics state corresponding to the logistics information is “In transit.”

In some embodiments, a logistics state is determined according to the logistics information mapping table and the logistics sub-node. A classification model may be used to directly determine a logistics state corresponding to logistics information. Specifically, the classification model may be a model constructed by training sample data of historical logistics information by using a classification algorithm In some embodiments, after unclassified logistics information is entered into the classification model, a result of classification may be the logistics state.

In some embodiments, the geographical location corresponding to each piece of logistics information may be determined. According to the logistics state corresponding to each piece of logistics information, a correspondence may be established between the geographical location of the logistics information and the logistics state of the logistics information. In this way, each geographical location in a delivery route has a corresponding logistics state. For example, a piece of logistics information is “The logistics package enters Xiangyang Forwarding Center.” In such case, a corresponding geographical location determined for the logistics information is “Xiangyang,” and the determined logistics state of the logistics information is “In transit.” Therefore, a correspondence between the geographical location “Xiangyang” and the logistics state “In transit” is established.

At S403, according to an order of the logistics information, a delivery route of the logistics package is generated that sequentially traverses the geographical locations corresponding to the logistics information. This step is the same as step S203 in the method for processing a delivery route of a logistics package shown in FIG. 2. Details are not described herein.

At S404, after receiving a search request of a terminal for a delivery route of a target logistics package is, a target delivery route corresponding to the target logistics package and logistics states corresponding to the geographical locations in the target delivery route are returned to the terminal, where the target delivery route and the logistics states are displayed on the terminal. It should be noted that this step is approximately the same as step S204 in the method for processing a delivery route of a logistics package shown in FIG. 2. A difference may be that the data returned to the terminal not only includes the target delivery route, but also includes a logistics state corresponding to each geographical location in the target delivery route. In some embodiments, the target delivery route and the logistics states are displayed on the terminal.

It should be noted that the logistics states returned to the terminal are logistics states corresponding to all geographical locations in the target delivery route. In some embodiments, a last geographical location in the target delivery route may be determined, and only the logistics state corresponding to the last geographical location may be returned.

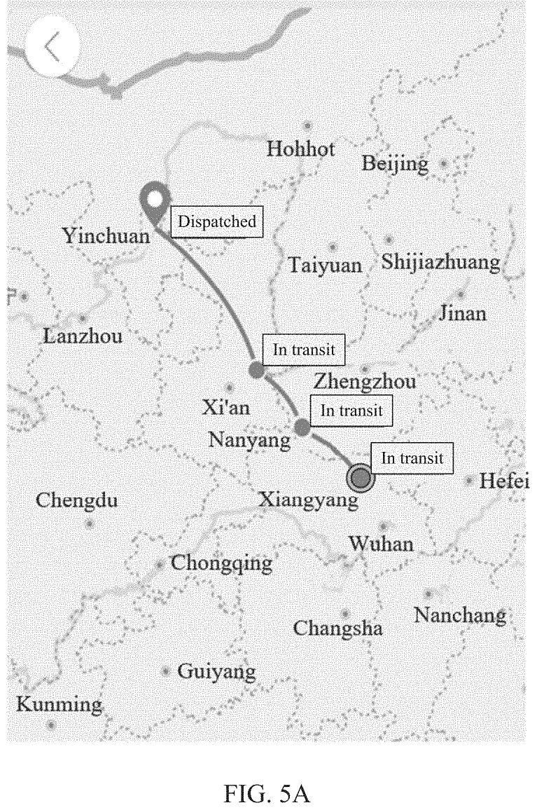

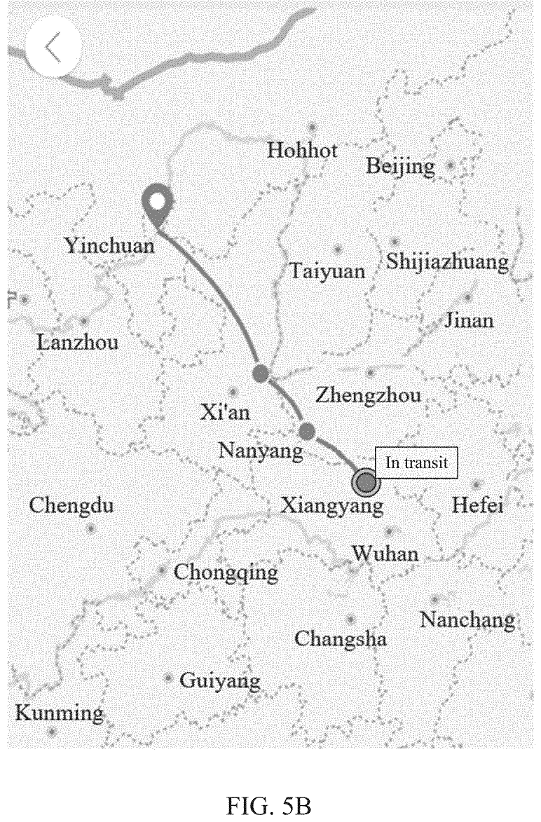

For example, if the logistics state corresponding to each geographical location in the target delivery route is returned to the terminal, all logistics states may be displayed on the terminal. As shown in FIG. 5A, the target delivery route displayed by the terminal includes the geographical locations “Yinchuan,” “Xi'an,” “Nanyang,” and “Xiangyang,” and a logistics state is correspondingly displayed for each geographical location. Specifically, the logistics state corresponding to the geographical location “Yinchuan” is “Dispatched,” the logistics state corresponding to the geographical location “Xi'an” is “In transit,” the logistics state corresponding to the geographical location “Nanyang” is “In transit,” and the logistics state corresponding to the geographical location “Xiangyang” is “In transit.”

In another example, if the logistics state corresponding to each geographical location in the target delivery route is returned to the terminal, a last geographical location in the target delivery route is determined such that the logistics state corresponding to the last geographical location is displayed. As shown in FIG. 5B, the target delivery route displayed by the terminal includes the geographical locations “Yinchuan,” “Xi'an,” “Nanyang,” and “Xiangyang.” A corresponding logistics state “In transit” is displayed for only the geographical location “Xiangyang.” In this case, when a user enters a search instruction of a logistics state through the terminal (e.g. clicking an icon of the geographical location “Yinchuan”) the terminal may further display the logistics state corresponding to the geographical location.

In some embodiments, a display style such as colors or sizes of the last geographical location in the target delivery route may be different from display styles of other geographical locations, which may remind the user that the geographical location is a geographical location corresponding to a last piece of logistics information of the plurality of pieces of logistics information (i.e. a current geographical location of the logistics package). For example, the size of an icon of the geographical location “Xiangyang” is larger than the icons of other geographical locations in FIG. 5A and FIG. 5B. The display styles of FIG. 5A and FIG. 5B are only an example for description, and other display styles may further be used.

In some embodiments, both a delivery route of a logistics package and logistics states corresponding to geographical locations in the delivery route may be returned to the terminal, and both the delivery route and the logistics states can be displayed on the terminal. In this way, a user can visually check not only a route of a logistics package during logistics delivery, but also a logistics stage of the logistics package during delivery, thereby achieving better user experience.

In some embodiments, the delivery route displayed in the foregoing embodiment may be a current delivery route of the logistics package in a logistics process. Specifically, when the logistics package is currently at a geographical location, the delivery route displayed on the terminal may end at the geographical location. In some embodiments, if the current delivery route is not a complete delivery route from an origin to a destination, the remaining delivery route may be estimated, and the current delivery route and the estimated remaining delivery route may be displayed together on the terminal.

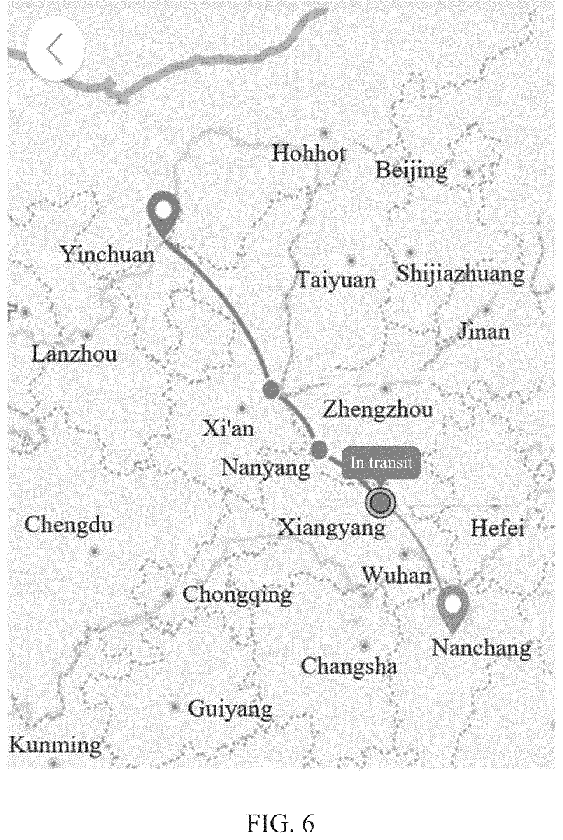

Specifically, the origin and the destination of the logistics package during logistics delivery may be obtained, and a corresponding preset delivery route may be determined according to the origin and the destination. In some embodiments, after the target delivery route is determined, if the target delivery route is a part of a preset delivery route, both the remaining route of the preset delivery route and the target delivery route may be returned to the terminal The terminal may display both the target delivery route and the remaining route. In some embodiments, as shown in FIG. 6, the relatively thick part (the route from Yinchuan to Xiangyang) of a delivery route is the target delivery route, and the relatively thin part (the route from Xiangyang to Nanchang) is the remaining route. It should be noted that a method for displaying the target delivery route may be the same as or different from a method for displaying the preset delivery route. To facilitate the use, the target delivery route and the preset delivery route may be displayed in different display styles, including but not limited to, a line thickness, a line color, and a line style.

In some embodiments, a manner of determining the preset delivery route according to an origin and a destination is determining a preset delivery route in prestored preset delivery routes, in which the origin and the destination are respectively the same as those of a target logistics package.

It should be noted that the method for processing a delivery route of a logistics package may be applied to the first server, and a logistics system may provide the preset delivery routes to the first server. In this way, the first server may directly determine a corresponding preset delivery route according to an origin and a destination. According to a large amount of historical logistics data, the logistics system may maintain a plurality of preset delivery routes (i.e. possible routes of a logistics package from an origin to a destination). In some embodiments, a user may view a current delivery route of a logistics package, and further view a possible subsequent route in advance.

In some embodiments, a delivery route may be generated, and a logistics state time axis may further be generated according to logistics states corresponding to the delivery route. Specifically, the logistics states corresponding to the geographical locations in the delivery route may be determined. If the logistics states include repetitive logistics states, the repetitive logistics states other than the last logistics state may be removed.

It should be noted that the logistics state “In transit” may appear repetitively. The repetitive logistics states other than the last logistics state are removed, and only the logistics state “In transit” at the last transfer time point may be kept to reflect a time point at which the logistics package is most recently in the logistics state “In transit.”

In some embodiments, a time point corresponding to a logistics state may be obtained. The time point may be a transfer time point corresponding to logistics information corresponding to a logistics state. For example, a transfer time point corresponding to the logistics state “Accepted” is “22:08, February 9,” a transfer time point corresponding to the logistics state “Dispatched” is “08:08, February 20,” and a transfer time point corresponding to the logistics state “In transit” is “09:13, February 20.”

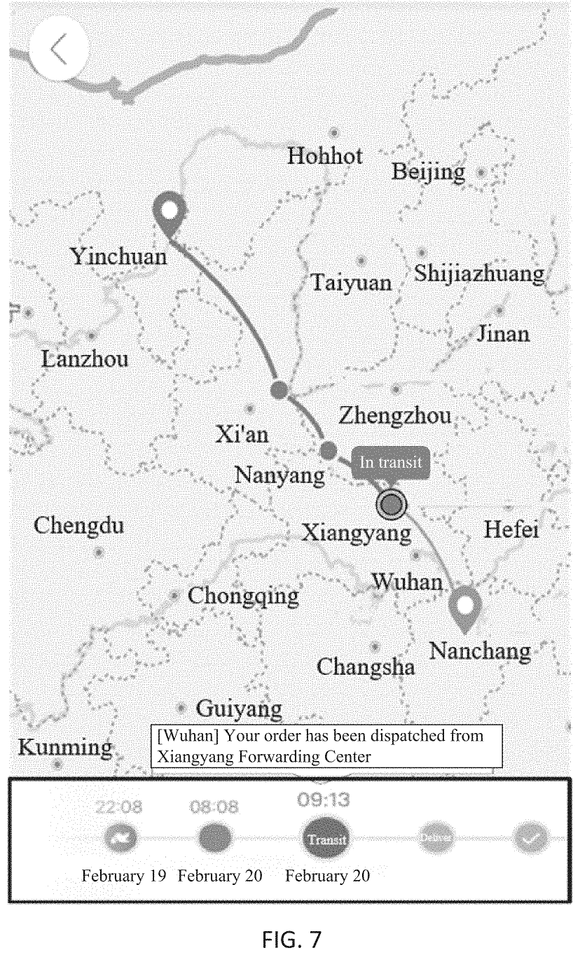

In some embodiments, a logistics state time axis may be generated according to the logistics states and transfer time points corresponding to the logistics states. The logistics state time axis sequentially includes the transfer time points, and includes the logistics states corresponding to the transfer time points. A logistics state may be displayed in various styles such as a text, a still image, and an animation. As shown in FIG. 7, a time axis in a rectangular box (which is only used to show the logistics state time axis, and there may be no rectangular box during actual application) is one form of the logistics state time axis displayed by the terminal. The logistics states on the logistics state time axis are in a display style of icons. The icons sequentially indicate the logistics state “Accepted,” the logistics state “Dispatched,” and the logistics state “In transit,” each of which has a corresponding transfer time point.

In some embodiments, all logistics states that need to be included in a logistics procedure may be preset. If the generated logistics state time axis only includes partial logistics states, the remaining logistics states may also be added to the logistics state time axis, which, however, do not have corresponding transfer time points. As shown in FIG. 7, the fourth logistics state and the fifth logistics state on the logistics state time axis indicate “Delivering” and “Received and signed for” respectively. When the target delivery route is returned to the terminal, the logistics state time axis corresponding to the target delivery route may further be returned. The logistics state time axis is displayed on the terminal for the user to visually check the transfer time points corresponding to the logistics states of the logistics package.

In some embodiments, a correspondence between a logistics state and logistics information may further be established. When the logistics state time axis is returned, logistics information corresponding to the logistics states on the logistics state time axis may further be returned. The terminal may indicate, in response to a user's logistics information search instruction, logistics information corresponding to a logistics state corresponding to the logistics information search instruction. For example, as swhon in FIG. 7, the user clicks an icon of the logistics state “Transit” on the logistics state time axis, and the logistics state is “In transit.” In this case, logistics information corresponding to the logistics state “In transit” is “[Wuhan] Your order has been dispatched from Xiangyang Forwarding Center.”

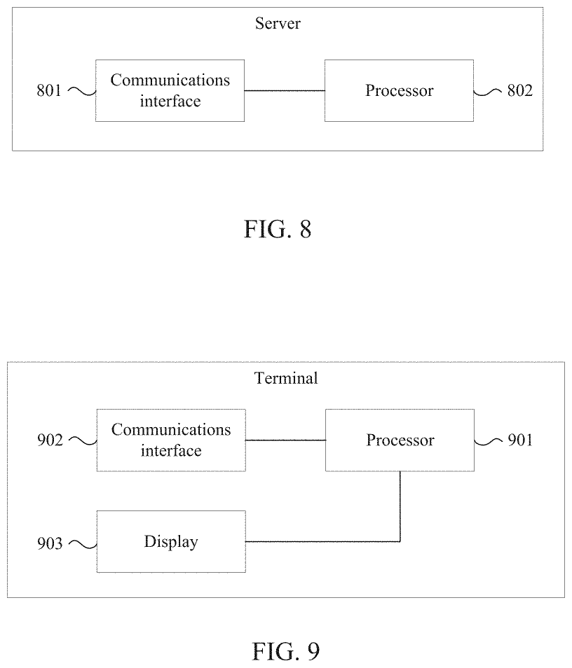

FIG. 8 illustrates a block diagram of a server in accordance with some embodiments. The server may include a communications interface 801 and a processor 802. The communications interface 801 may be configured to obtain a plurality of pieces of logistics information of a logistics package, and send the plurality of pieces of logistics information of the logistics package to the processor 802.

The processor 802 may be configured to determine, after receiving the plurality of pieces of logistics information of the logistics package, a plurality of geographical locations corresponding to the plurality of pieces of logistics information. The processor 802 may sort the plurality of pieces of logistics information, and determine a sorting result as an order of the plurality of geographical locations. The processor 802 may generate, according to the order of the plurality of geographical locations, a delivery route that sequentially traverses the geographical locations.

In some embodiments, the communications interface 801 may be configured to: receive a search request of a terminal for a delivery route of a target logistics package, send the search request to the processor, and return a target delivery route to the terminal The processor 802 may be further configured to determine, after receiving the search request, a target delivery route corresponding to the target logistics package, and send the target delivery route to the communications interface.

In some embodiments, the processor 802 may be further configured to determine, after receiving the plurality of pieces of logistics information of the logistics package, logistics states corresponding to the plurality of pieces of logistics information, and establish a correspondence between the logistics states and the geographical locations. The processor 802 may be configured to determine a target logistics sub-node corresponding to each piece of logistics information. The processor 802 may be configured to determine, according to a preset correspondence between a logistics sub-node and a logistics state, a logistics state corresponding to the target logistics sub-node. In some embodiments, the processor 802 may be further configured to obtain a transfer time point corresponding to the logistics information, and establish a correspondence between the transfer time point and a logistics state corresponding to the logistics information. The processor 802 may be further configured to generate a logistics state time axis of the logistics package according to the transfer time point and the correspondence between the transfer time point and the logistics state.

In some embodiments, the processor 802 may be further configured to determine, after receiving a search request of a terminal for a delivery route of a target logistics package, a target delivery route corresponding to the target logistics package. The processor may determine a logistics state time axis corresponding to the target logistics package. The processor 802 may be further configured to send the target delivery route and the logistics state time axis to the communications interface 801. The communications interface 801 may be further configured to return the target delivery route and the logistics state time axis to the terminal

In some embodiments, the processor 802 may be further configured to determine, after receiving a search request of a terminal for a delivery route of a target logistics package, a target delivery route corresponding to the target logistics package. The processor may determine logistics states corresponding to geographical locations in the target delivery route, and send the target delivery route and the logistics states corresponding to the geographical locations in the target delivery route to the communications interface 801. The communications interface 801 may be further configured to return the target delivery route and the logistics states corresponding to the geographical locations in the target delivery route to the terminal.

In some embodiments, the processor 802 may be specifically configured to determine a last geographical location in the target delivery route, and determine a logistics state corresponding to the last geographical location. The processor 802 may send the target delivery route and the logistics state corresponding to the last geographical location to the communications interface 801. In some embodiments, the processor 802 may be configured to determine all logistics states corresponding to the geographical locations in the target delivery route, and send the target delivery route and all the logistics states corresponding to the geographical locations to the communications interface 801.

In some embodiments, the processor 802 is further configured to determine, after receiving a search request of a terminal for a delivery route of a target logistics package, preset delivery routes corresponding to the target logistics package according to a logistics origin and a logistics destination corresponding to the target logistics package. The processor 802 may determine, in the determined preset delivery routes, a target delivery route corresponding to the target logistics package. The processor 802 may send the preset delivery routes and the target delivery route to the communications interface. The communications interface 801 is further configured to return the preset delivery routes and the target delivery route to the terminal

FIG. 9 illustrates a block diagram of a terminal in accordance with some embodiments. The terminal may include a processor 901, a communications interface 902, and a display 903. The processor 901 may be configured to generate, in response to a user's search instruction for a target logistics package, a search request for a delivery route of the target logistics package. The search request may be used by a server to determine a target delivery route corresponding to the target logistics package and return the target delivery route to the terminal, and send the search request to the communications interface 902.

The communications interface 902 may be configured to send the search request to the server, and receive the target delivery route from the server. The display 903 may be configured to display the target delivery route in a first display style on a preset map. In some embodiments, the search request may be further used for the server to determine, according to a logistics origin and a logistics destination corresponding to the target logistics package, a preset delivery route corresponding to the target logistics package and return the preset delivery route to the terminal The communications interface 902 may be further configured to receive the preset delivery route from the server. The display 903 may be further configured to display the preset delivery route in a second display style on the preset map. In some embodiments, a display style of a last geographical location in the target delivery route is different from display styles of other geographical locations in the target delivery route.

In some embodiments, the search request may be further used by the server to determine a logistics state time axis corresponding to the target logistics package and return the logistics state time axis to the terminal. The communications interface 902 may be further configured to receive the logistics state time axis from the server.

In some embodiments, the display 903 may be further configured to display the logistics state time axis. In some embodiments, the search request may be further used by the server to determine logistics states corresponding to geographical locations in the target delivery route and return the logistics states corresponding to the geographical locations in the target delivery route to the terminal The communications interface 902 may be further configured to receive the logistics states from the server and correspond to the geographical locations in the target delivery route. The display 903 may be further configured to display the logistics states corresponding to the geographical locations in the target delivery route.

It should be noted that the embodiments in this specification are all described in a progressive manner. Description of each of the embodiments focuses on differences from other embodiments, and reference may be made to each other for the same or similar parts among respective embodiments.

It should further be noted that the relational terms herein such as first and second are used only to differentiate an entity or operation from another entity or operation, and do not require or imply any actual relationship or sequence between these entities or operations. Moreover, the terms “include,” “comprise,” and any variation thereof are intended to cover a non-exclusive inclusion.” Therefore, in the context of a process, a method, an object, or a device that includes a series of elements, the process, method, object, or device not only includes such elements, but also includes other elements not specified expressly, or may include inherent elements of the process, method, object, or device. If no more limitations are made, an element limited by “include a/an...” does not exclude other same elements existing in the process, the method, the article, or the device which includes the element.

The foregoing description of the disclosed embodiments enables a person skilled in the art to implement or use this application. It is apparent to a person skilled in the art to make various changes to these embodiments. The general concept defined in the specification may be implemented in other embodiments without departing from the spirit and scope of this application. Therefore, this application is not limited to these embodiments shown in the specification, and instead is to meet the widest range consistent with the principles and novel features disclosed in the specification.

What is claimed is:

1. A method for processing a delivery route of a logistics package, the method comprising:
determining a plurality of geographical locations corresponding to a plurality of pieces of logistics information of the logistics package;
sorting the plurality of pieces of logistics information to generate an order of the plurality of geographical locations; and
determining, according to the order of the plurality of geographical locations, a delivery route of the logistics package that sequentially traverses the geographical locations.

2. The method for processing a delivery route of a logistics package according to claim 1, further comprising:
determining, after receiving a search request of a terminal for a delivery route of a target logistics package, a target delivery route corresponding to the target logistics package, and returning to the terminal the target delivery route.

3. The method for processing a delivery route of a logistics package according to claim 1, wherein after obtaining the plurality of pieces of logistics information of the logistics package, the method further comprises:
determining logistics states corresponding to the plurality of pieces of logistics information; and
establishing a correspondence between the logistics states and the geographical locations.

4. The method for processing a delivery route of a logistics package according to claim 3, wherein the determining logistics states corresponding to the plurality of pieces of logistics information comprises:
determining a target logistics sub-node corresponding to each piece of logistics information; and
determining, according to a preset correspondence between logistics sub-nodes and logistics states, a logistics state corresponding to the target logistics sub-node.

5. The method for processing a delivery route of a logistics package according to claim 3, further comprising:
obtaining a transfer time point corresponding to the logistics information, and establishing a correspondence between the transfer time point and a logistics state corresponding to the logistics information; and
generating, according to the transfer time point and the correspondence between the transfer time point and the logistics state, a logistics state time axis of the logistics package.

6. The method for processing a delivery route of a logistics package according to claim 5, further comprising:
determining, after receiving a search request of a terminal for a delivery route of a target logistics package, a target delivery route corresponding to the target logistics package, and determining a logistics state time axis corresponding to the target logistics package; and
returning to the terminal the target delivery route and the logistics state time axis.

7. The method for processing a delivery route of a logistics package according to claim 3, further comprising:
determining, after receiving a search request of a terminal for a delivery route of a target logistics package, a target delivery route corresponding to the target logistics package,
determining logistics states corresponding to geographical locations in the target delivery route; and
returning to the terminal the target delivery route and the logistics states corresponding to the geographical locations in the target delivery route.

8. The method for processing a delivery route of a logistics package according to claim 7, wherein the determining logistics states corresponding to the geographical locations in the target delivery route comprises:
determining a last geographical location in the target delivery route; and
determining a logistics state corresponding to the last geographical location; and
wherein the returning to the terminal the target delivery route and the logistics states corresponding to the geographical locations in the target delivery route comprises:
returning to the terminal the target delivery route and the logistics state corresponding to the last geographical location.

9. The method for processing a delivery route of a logistics package according to claim 7, wherein the determining logistics states corresponding to the geographical locations in the target delivery route comprises:
determining all logistics states corresponding to the geographical locations in the target delivery route; and
wherein the returning to the terminal the target delivery route and the logistics states corresponding to the geographical locations in the target delivery route comprises:
returning to the terminal the target delivery route and all the logistics states corresponding to the geographical locations.

10. The method for processing a delivery route of a logistics package according to claim 1, further comprising:
determining, after receiving a search request of a terminal for a delivery route of a target logistics package, preset delivery routes according to a logistics origin and a logistics destination corresponding to the target logistics package;
determining, in the determined preset delivery routes, a target delivery route corresponding to the target logistics package; and
returning to the terminal the preset delivery route and the target delivery route.

11. A method for processing a delivery route of a logistics package, applied to a terminal, the method comprising:
sending, in response to a search instruction of a user for a target logistics package, to a server a search request for a delivery route of the target logistics package, wherein the search request is used by the server to determine a target delivery route corresponding to the target logistics package and return to the terminal the target delivery route;
receiving the target delivery route from the server; and
displaying the target delivery route in a first display style on a map.

12. The method for processing a delivery route of a logistics package according to claim 11, wherein the server is further configured to determine, according to a logistics origin and a logistics destination corresponding to the target logistics package, a preset delivery route corresponding to the target logistics package and return to the terminal the preset delivery route; and
the method further comprises:
receiving the preset delivery route from the server; and
displaying the preset delivery route in a second display style on the map.

13. The method for processing a delivery route of a logistics package according to claim 11, wherein a display style of a last geographical location in the target delivery route is different from display styles of other geographical locations in the target delivery route.

14. The method for processing a delivery route of a logistics package according to claim 11, wherein the server is further configured to determine a logistics state time axis corresponding to the target logistics package and return to the terminal the logistics state time axis; and
the method further comprises:
receiving the logistics state time axis from the server; and
displaying the logistics state time axis.

15. A server, comprising:
a communications interface, configured to obtain a plurality of pieces of logistics information of a logistics package;
a processor; and
wherein the plurality of pieces of logistics information of the logistics package is sent to the processor via the communications interface;
wherein the processor is configured to: determine a plurality of geographical locations corresponding to the plurality of pieces of logistics information; sort the plurality of pieces of logistics information as an order of the plurality of geographical locations; determine, according to the order of the plurality of geographical locations, a delivery route of the logistics package that sequentially traverses the geographical locations.

16. The server according to claim 15, wherein the communications interface is further configured to:
receive a search request of a terminal for a delivery route of a target logistics package;
send to the processor the search request; and
return to the terminal a target delivery route; and
wherein the processor, based on the search request, is further configured to:
determine a target delivery route corresponding to the target logistics package; and
send to the communications interface the target delivery route.

17. The server according to claim 15, wherein the processor is further configured to:
determine, after receiving the plurality of pieces of logistics information of the same logistics package, logistics states corresponding to the plurality of pieces of logistics information; and
establish a correspondence between the logistics states and the geographical locations.

18. The server according to claim 17, wherein the processor being configured to determine logistics states corresponding to the plurality of pieces of logistics information comprises:
determining a target logistics sub-node corresponding to each piece of logistics information; and
wherein the processor is configured to determine, according to a preset correspondence between logistics sub-nodes and logistics states, a logistics state corresponding to the target logistics sub-node.

19. The server according to claim 17, wherein the processor is further configured to:
obtain a transfer time point corresponding to the logistics information, and establish a correspondence between the transfer time point and a logistics state corresponding to the logistics information; and
generate a logistics state time axis of the logistics package according to the transfer time point and the correspondence between the transfer time point and the logistics state.

20. The server according to claim 15, wherein the processor is further configured to:
determing, after receiving a search request of a terminal for a delivery route of a target logistics package, preset delivery routes corresponding to the target logistics package according to a logistics origin and a logistics destination corresponding to the target logistics package;
determine, in the determined preset delivery routes, a target delivery route corresponding to the target logistics package; and
send to the communications interface the preset delivery route and the target delivery route; and
wherein the communications interface is further configured to return to the terminal the preset delivery route and the target delivery route.
